(19) United States
(12) Patent Application Publication
(10) Pub. No.: US 2007/0109271 A1
(43) Pub. Date: May 17, 2007

(54) [A PORTABLE STORAGE DEVICE WITH HANDWRITTEN INPUT DEVICE]

(75) Inventor: Chih-Ling Wang, TAIPEI (TW)

Correspondence Address: PHISON ELECTRONICS CORPORATION, 2F-4. NO. 148, SEC. 4, CHUNG HSIAO EAST ROAD, TAIPEI, TW

(73) Assignee: PHISON ELECTRONICS CORP., Chutung Town, Hsinchu Hsien (TW)

(21) Appl. No.: 11/164,172

(22) Filed: Nov. 14, 2005

(51) Int. Cl. G09G 5/00

(52) U.S. Cl. 345/173

(57) ABSTRACT

A portable storage device with handwritten input device is provided. The portable storage device comprises a storage device and an input device. When the storage device is electrically connected to a host end, an execution program installed in the host end can read coordinates data and the displacement data stored in a flash memory of the storage device and then analyzes and integrates the coordinates data and the displacement data and calculates the coordinates to convert into corresponding text or image files.

### BACKGROUND OF INVENTION

1. Field of the Invention

The present invention relates to a portable storage device with handwritten input device, and more particularly to a portable storage device with handwritten input device, wherein the coordinates data and the displacement data of the input device can be saved into the storage device, and the execution program of the host end can read the coordinates data and the displacement data stored in the flash memory and can be further converted into the corresponding text or image files in order to enable the user to use anywhere.

2. Description of Related Art

Nowadays, most of the documents and files are digital, for example, fliers, reports, students' assignment, companies documents and author's article. Computer plays an important role for editing the aforementioned documents and files. Regardless of the kind of documents or articles, text is very important for expressing the contents of the documents, so it remains unchanged whether or not the documents or articles are digitalized. Therefore, the method of inputting text is very important.

For inputting Chinese fonts, the easiest method for the learner is CHU-YIN input method, but the efficiency of inputting using CHU-YIN can be comparatively less because the user has to choose the right font among all the fonts having the same pronunciation. The user may also choose other input method, for example, CHAN-JAY, to input the Chinese font by separating the font piece by piece. However, the user has to practice the rule of keying Chinese font using chan-jay input method and also has to memorize the position of the keys. If the user is not really familiar with the rules and the position of the keys, the inputting efficiency may not be higher than that of chu-yin input method.

Therefore, some manufacturers developed handwriting input device to overcome the above defects, which does not require the user to be well-trained in inputting font using the aforementioned input methods. Accordingly, handwriting input device has become very popular. The handwriting input device, in the earlier stage, comprises a handwriting board connected to the computer; the user may use a pen or finger to write on the handwriting board. The software of the handwriting board or the computer converts the trace movement of the pen or the finger on the handwriting board into the corresponding text or image. This technology has been applied in PDA, notebook computer and cellular phone.

Nevertheless, pen is an essential item regardless of the improvement of the handwriting board. Besides, large size handwriting board is not suitable to carry. On the other hand, small size handwriting board is not convenient for inputting as the sensing area of the small size handwriting board is limited.

Additionally, the handwriting board has to be connected to the electronic devices such as computer, PDA, tablet computer or notebook computer in order to input texts or images. Now-a-days, PDA or tablet computer is equipped with input device that allows users to directly input text or image via the display panel using a pen and touch panel functions to operate like mouse and keyboard. However, PDA and tablet computer are expensive, large and heavy.

Accordingly, the conventional handwriting input device has the following disadvantages.

1. For conventional handwriting input device, a variety of handwriting boards in various size and shape has been developed for providing convenience to the user. However, the handwriting board has the disadvantages large space occupation and limited portability. Thus, it is inconvenient to users.

2. A transmission cable is required for connecting the handwriting input device to the host end, such as the computer, notebook computer or PDA, for calculating the position of the font and the trace of the pen or finger. Therefore, the conventional handwriting device cannot work without being connected to the host end.

Therefore, how to overcome the above defects of the conventional handwriting input device is important issue for the manufacturers in the field.

### SUMMARY OF THE INVENTION

Accordingly, in the view of the foregoing, the present inventor makes a detailed study of related art to evaluate and consider, and uses years of accumulated experience in this field, and through several experiments, to create a portable storage device with handwritten input device.

According to an aspect of the present invention, the storage device comprises a receiving module for receiving and transmitting coordinates data and displacement data from a transmission module of an input device to a microprocessor, and the microprocessor transmits the coordinates data and the displacement data to a flash memory for storage. When the microprocessor of the storage device is electrically connected to a host end via a data transmission interface, the coordinates data and the displacement data stored in the flash memory is transmitted to the host end, and an execution program of the host end analyzes and integrates the coordinates data and the displacement data into corresponding text or image files. Therefore, for inputting via the input device of the present invention, the input device need not be electrically connected to any electronic devices such as computer or PDA. Accordingly, the disadvantages of the prior art can be effectively resolved and portability is substantially enhanced so that the user may input and store data into the storage device at any location.

### BRIEF DESCRIPTION OF THE DRAWING

FIG. 1 is a block diagram of a portable storage device according to an embodiment of the present invention.

FIG. 2 is a flowchart of an operation procedure of inputting according to an embodiment of the present invention.

FIG. 3 is a flowchart of an operation procedure of connecting a host end to the storage device according to an embodiment of the present invention.

### DETAIL DESCRIPTION OF THE EMBODIMENTS

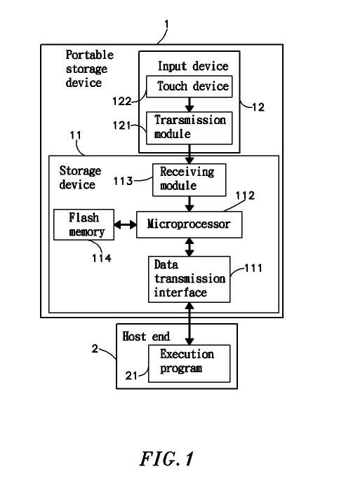

Referring to FIG. 1, a portable storage device 1 in accordance with the present invention is shown comprised of a storage device 11 and an input device 12.

The storage device 111 comprises a data transmission interface 111 electrically connected to a microprocessor 112. The microprocessor 112 is electrically connected to a receiving module 113 and a flash memory 114.

The data transmission interface 111 may be IEEE1394 (Institute of Electrical and Electronic Engineers Standard Bus Interface), USB (Universal Serial Bus), SATA (Serial Advanced Technology Attachment), IDE (Integrated Device Electronics) or SCSI (Small Computer Standard Interface). The flash memory 114 may be AND, NAND, or NOR type. The receiving module 113 may be SPI (Serial Peripheral Interface) or UART (Universal Asynchronous Receiver/transmitter).

The input device 12 comprises a transmission module 121 for transmitting signals of coordinates data and displacement data and a touch device 122 for generating touch signals.

When a user wants to input by using the input device 12, the touch device 122 is operated to generate a touch signal and then transmits the touch signal and a corresponding coordinates data of the touch signal in an orderly manner to the receiving module 113 and the microprocessor 112 of the storage device 11 via the transmission module 121. The microprocessor 112, after receiving the touch signal and the corresponding coordinates data of the touch signal, learns that the input device 12 is ready for inputting and transmits the corresponding coordinates data of the touch signal to the flash memory 114 for storage. At the same time, the user can start writing by using the input device 12 and the input device 12 starts to generate coordinates data and displacement data according to the user's inputted information and transmits the coordinates data and the displacement data to the receiving module 113 and the microprocessor 112 via the transmission module 121, and then the microprocessor 112 transmits the coordinates and the displacement data to the flash memory 114 for storage.

The communication between the receiving module 113 of the storage device 11 and the transmission module 121 of the input device 12 can be implemented by wired or wireless transmission protocol. The wireless transmission protocol may be comprised of infrared, ZigBee or blue tooth.

Furthermore, the input device 12 can be a handwritten pen or any element that can be used for writing. The touch device 122 of the input device 12 can be buttons, a fine-adjustment switch or a pen point of the handwritten pen.

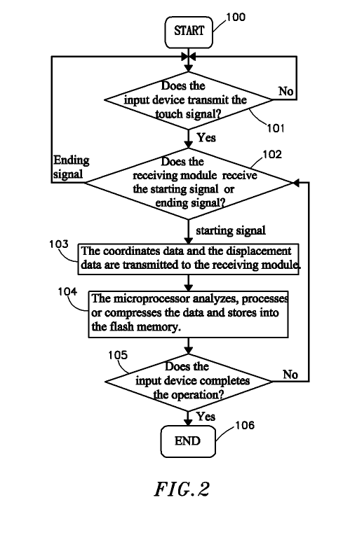

Hereinafter, the operation procedure of inputting according to an embodiment of the present invention is described with reference to FIGS. 1 and 2 as follows.

At step 100, the procedure starts.

At step 101, the touch device 122 generates a touch signal corresponding to the user's handwriting, and the microprocessor 112 senses whether the input device 12 transmits the touch signal via the receiving module 113, wherein when the input device 12 transmits the touch signal, the procedure proceeds to step 102, otherwise the microprocessor 112 keeps sensing whether the input device 12 transmits the touch signal.

At step 102, the microprocessor 112 continues to sense whether the receiving module 113 receives a starting or ending signal transmitted from the input device 12, wherein when the receiving module 113 receives the starting signal, the procedure proceeds to step 103, otherwise, the procedure returns to step 101.

At step 103, in response to the movement of the input device 12, the transmission module 121 of the input device 12 transmits coordinates data and displacement data to the receiving module 113 of the storage device 11, the procedure continues to the next step 104.

At step 104, the receiving module 113 of the storage device 11 transmits the coordinates data and the displacement data to the microprocessor 112, the microprocessor 112 analyzes, processes or compresses the coordinates data and the displacement data and then stores into the flash memory 114, the procedure proceeds to step 105.

At step 105, whether or not the input device 12 completes the operation is determined, if yes, the procedure proceeds to step 106, otherwise the procedure returns to step 102.

At step 106, the procedure ends.

The above touch device 122 generates and transmits the touch signal together with the corresponding coordinates data of the touch signal to the microprocessor 112. The microprocessor 112 initializes the storage device 11 for inputting while receiving the touch signal and uses the corresponding coordinates data of the touch signal as the coordinate data and the displacement data of the starting point for the user using the input device 12 to write. The touch device 122 starts to transmit the starting signal to the microprocessor 112 while the touch signal is being generated and the microprocessor 112 uses the starting signal as the coordinates data and the displacement data of the starting point.

The switch to generate the above starting or ending signal can be the touch device 122, buttons, a fine adjustment switch or other similar type of switch.

Referring to FIG. 1, when the storage device 11 is electrically connected to a host end 2 via the data transmission interface 111, an execution program 21 installed in the host end 2 can read the coordinates data and the displacement data stored in the flash memory 114 of the storage device 111 and then analyzes and integrates the coordinates data and the displacement data, such as the calculation of the coordinates, the calculation of the distance of the coordinate and the connection of the points of the coordinates, to convert into corresponding text or image files to enable the user to browse and edit. Furthermore, the user may also store the data to the flash memory 114 of the storage device 111 via the host end 2.

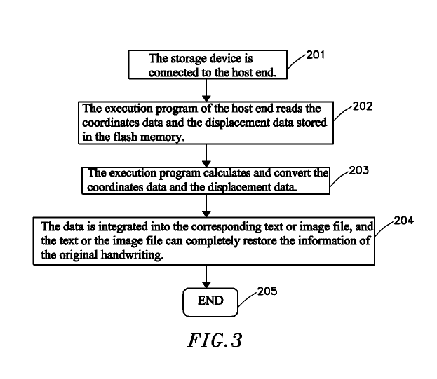

Hereinafter, the operation procedure of connecting the host end with the storage device is described with reference to FIGS. 1 and 3 as follows.

At step 201, the storage device 11 is connected to the host end 2.

At step 202, the execution program 21 of the host end 2 reads the coordinates data and the displacement data stored in the flash memory 114.

At step 203, the execution program 21 calculates the coordinates data and the displacement data, and saves the calculation result in text, symbol or image files.

At step 204, the data is analyzed and integrated into corresponding text or image files, and the text or the image files can completely restore the data of the original handwriting.

At step 205, the procedure ends.

The host end 2 may be a computer, a notebook computer or a PDA (personal digital assistance).

Accordingly, the portable storage device of the present invention has at least the following advantages.

1. The user can write by using the input device 12 directly without using the handwritten board, and therefore the user need not carry any additional device.

2. The input device 12 of the present invention need not be electrically connected to the host end 2 and the user can write by using the input device 12 directly and store into the storage device 11. Thus, the present invention provides a greater convenience to the user, in that, the storage device 11 of the present invention can be easily carried anywhere and information can be conveniently input and store in the storage device 11. For example, the conference or business meeting information may be input and stored directly into the storage device 11 of the present invention and the user may need not use the conventional notepad, telephone book or agenda book.

3. The storage device 111 and the input device 12 of the present invention can transmit the signals wirelessly without the wire connection, and accordingly, the efficiency can be effectively promoted.

4. After the storage device 111 of the present invention is electrically connected to the host end 2, the user can run the execution program 21 installed in the host end 2 to read the data stored in the flash memory 114 of the storage device 11. The data may be further converted into the corresponding text or image files and may also store into the flash memory 114 of the storage device 111 through the host end 2.

A prototype of portable storage device has been constructed with the features of FIG. 1˜3. The portable storage device functions smoothly to provide all of the features discussed earlier.

Although a particular embodiment of the invention has been described in detail for purposes of illustration, various modifications and enhancements may be made without departing from the spirit and scope of the invention.

What is claimed is:

1. A portable storage device with handwritten input device, comprising:
a storage device, comprising a flash memory, a microprocessor electrically connected to said flash memory, a receiving module and a data transmission interface, wherein said data transmission interface is electrically connected to a host end, said microprocessor and said receiving module; and
an input device, comprising a touch device for generating touch signals, displacement signals and coordinates data, and a transmission module for transmitting signals to said receiving module.

2. The portable storage device with handwritten input device as claimed in claim 1, wherein said data transmission interface comprises an IEEE1394 (Institute of electrical and electronic engineers standard bus interface), a USB (universal serial bus), a SATA (serial advanced technology attachment), an IDE (integrated device electronics) or a SCSI (small computer standard interface).

3. The portable storage device with handwritten input device as claimed in claim 1, wherein said flash memory comprises an AND type, a NAND type or a NOR type.

4. The portable storage device with handwritten input device as claimed in claim 1, wherein said receiving module comprises a SPI (serial peripheral interface) or a UART (universal asynchronous receiver/transmitter).

5. The portable storage device with handwritten input device as claimed in claim 1, wherein said receiving module and said transmission module communicate in wired or wireless transmission mode.

6. The portable storage device with handwritten input device as claimed in claim 5, wherein said wireless transmission mode between said receiving module and said transmission module comprises infrared, ZigBee or blue-tooth.

7. The portable storage device with handwritten input device as claimed in claim 1, wherein said host comprises an execution program for analyzing, processing or compressing data.

8. The portable storage device with handwritten input device as claimed in claim 1, wherein said touch device comprises a button, a fine-adjustment switch or a pen point of a handwritten pen.
